(19) United States
(12) Patent Application Publication
(10) Pub. No.: US 2006/0064827 A1
(43) Pub. Date: Mar. 30, 2006

(54) Electric toothbrush comprising elastomer

(75) Inventor: John Geoffrey Chan, Maineville, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/235,400

(22) Filed: Sep. 26, 2005

Related U.S. Application Data
(60) Provisional application No. 60/613,627, filed on Sep. 27, 2004.

(51) Int. Cl. A61C 17/22

(52) U.S. Cl. 15/22.1; 15/28; 15/22.2

(57) ABSTRACT

An electric toothbrush may have one or more bristle plates which have one or more elastomeric elements. The elastomeric elements may be various sizes and shapes, including a prophy cup.

### CROSS REFERENCE TO RELATED APPLICATION

This application claims the benefit of U.S. Provisional Application No. 60/613,627 filed on Sep. 27, 2004, the substance of which is incorporated herein by reference.

### FIELD OF THE INVENTION

The present invention relates to the field of electric toothbrushes having one or more elastomeric elements.

### BRIEF SUMMARY OF THE INVENTION

An electric toothbrush may comprise a handle having a motor, a head having a longitudinal axis, and a neck. The head may have a first bristle plate, a second bristle plate, and/or a third bristle plate. The first bristle plate may oscillate or rotate about an axis of rotation. The second bristle plate may reciprocate along the longitudinal axis of the head, transverse to the longitudinal axis of the head, or up and down from the head. The first bristle plate may have a plurality of elastomeric elements, including a prophy cup.

### BRIEF DESCRIPTION OF THE DRAWINGS

The present invention may take form in various components and arrangements of components, and in various techniques, methods, or procedures and arrangements of steps. The referenced drawings are only for purposes of illustrating preferred embodiments, they are not necessarily to scale, and are not to be construed as limiting the present invention.

FIG. 1 is a planar, partial sectional, top view of an electric toothbrush.

FIG. 2 is a planar top view of an alternate embodiment of a top portion of the electric toothbrush of FIG. 1, wherein the oscillating bristle plate comprises elastomeric elements.

FIG. 3 is a cross-sectional side view of the oscillating bristle plate of FIG. 2.

FIG. 4 is a cross-sectional side view of an alternate embodiment of the oscillating bristle plate of FIG. 3, wherein the outer row comprises elastomeric elements, and wherein the elastomeric elements in the outer row are taller than the elastomeric elements in the inner row.

FIG. 5 is a top view of an alternate embodiment of the oscillating bristle plate of FIG. 2, wherein the outer row comprises elastomeric elements and non-elastomeric bristle tufts.

FIG. 6 is a planar top view of an alternate embodiment of the oscillating bristle plate of FIG. 2, comprising non-elastomeric elongated tufts.

### DETAILED DESCRIPTION

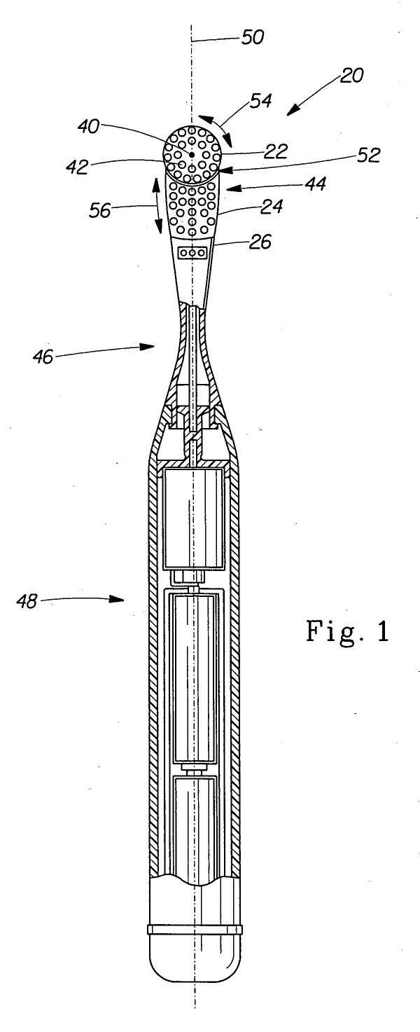

As shown in FIG. 1, a toothbrush 20 may comprise a head 44, a neck 46, and a handle 48. The handle 48 may comprise a motor. The head 44 may have a longitudinal axis 50 (which, as shown in FIG. 1, may be the same as a longitudinal axis of the handle 46, the head 44, and the toothbrush 20). The head 44 may have multiple bristle plates which may include moving and static bristle plates (a static bristle plate may also be referred to as a “static bristle field” and may be directly supported by the head 44 of the toothbrush 20). The head 44 may comprise an oscillating bristle plate 22, a reciprocating bristle plate 24, and a static bristle plate 26. The oscillating bristle plate 22 and/or reciprocating bristle plate 24 may oscillate or reciprocate along the longitudinal axis of the toothbrush 20, transverse to the longitudinal axis of the toothbrush 20, up and down from the toothbrush 20, or may move in another complex direction as describe in US Pat. App. Nos. 10/701,694, filed Nov. 5, 2003; 09/850,662, filed May 7, 2001; 10/036,613, filed Nov. 7, 2001; 09/993,167, filed Nov. 6 2001; 10/128,018, filed April 22, 2002; 10/208,213, filed July 30, 2002; 10/308,959, filed Dec. 3, 2002; 10/384,806, filed March 10, 2003; 10/410,038, filed April 9, 2003; and 10/825,792, filed April 16, 2004. The motion, relative to the longitudinal axis of the toothbrush 20, of a moving bristle plate should be considered its “moving motion”. The motion, relative to the longitudinal axis of the toothbrush 20, which a moving or static plate was designed to be moved by the user should be considered its “brushing motion”.

Also as shown in FIG. 1, the bristle plates may be arrange on the head 44 such that the oscillating bristle plate 22 is on the most distal end of the head 44, on the most proximal end of the head (that is, closest to the neck 46), or in the middle of the head 44 and flanked by other bristle plates. Additionally, gaps 52 may be formed between the bristle plates. The reciprocating bristle plate 24 may be oriented on the most distal end of the head 44, on the most proximal end of the head (that is, closest to the neck 46), or in the middle of the head 44 and flanked by other bristle plates. The static bristle plate 26 may be oriented on the most distal end of the head 44, on the most proximal end of the head (that is, closest to the neck 46), or in the middle of the head 44 and flanked by other bristle plates.

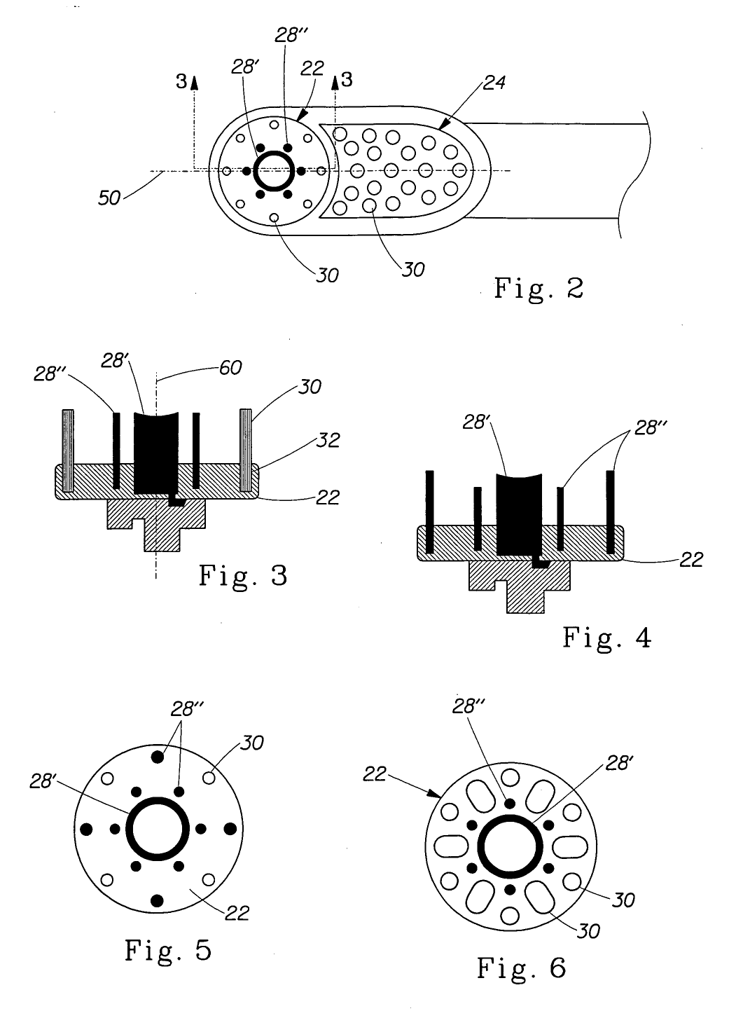

As shown in FIG. 2, the oscillating plate 22 may comprise one or more elastomeric elements 28′ and 28″. Multiple elastomeric elements 28′ and 28″ or non-elastomeric bristles may extend from an elastomeric base or from the bristle plate itself. For example, the elastomeric elements 28″ may extend from a traditional tuft hole 32 (see FIG. 3)). Additionally, the reciprocating bristle plate 24 and/or static bristle plate 26 may comprise one or more elastomeric elements 28′ and 28″.

The elastomeric elements 28′ and 28″ may also be referred to as “massaging tips/bristles/elements”, “polishing tips/bristles/elements”, or “whitening tips/bristles/elements”, and may include fingers and prophy cups. The elastomeric elements 28′ and 28″ may comprise a rubber or a rubber-like composition, including, but not limited to, styrene-ethylene-butylene-styrene block copolymers, silicone rubbers (including cross-linked polymers reinforced with silica, e.g., Silastic® manufactured by Dow Corning Corporation), as well as those compositions described in U.S. Pat. No. 6,151,745, filed on Jul. 12, 1999. The elastomeric elements 28′ and 28″ may have a shore A hardness greater than about 10, about 20, about 30, about 40, and less than about 50, about 60, about 70, and about 80.

The elastomeric elements 28′ and 28″ may be various shapes, including, but not limited to, cylindrical, oval, rectangular, triangular, or conical. The elastomeric elements 28′ and 28″ may be solid or may be completely (from end to end) or partially hollow. Hollow elastomeric elements 28′ and 28″ may be closed at both ends, or open at the top end (that is, the end which is not fixed to a bristle plate). The elastomeric elements 28′ and 28″ may be tapered or contoured. A single elastomeric element may form a wall (not shown). Examples of elastomeric walls and wall configurations are disclosed in U.S. Pat. App. No. 60/439,317, filed Jan. 10, 2003; 60/463,347, filed Apr. 15, 2003; U.S. Ser. No. 10/410,038, filed Apr. 9, 2003; U.S. Ser. No. 10/260,585, filed Sep. 27, 2002; and U.S. Ser. No. 10/260,586, filed Sep. 27, 2002; and in U.S. Pat. No. 6,319,332, filed Jun. 11, 1999; U.S. Pat. No. 6,571,417, filed Jun. 5, 2000; U.S. Pat. No. 6,446,295, filed on Jun. 26, 2000. The elastomeric elements 28′ and 28″ may extend at 90 degrees relative to the bristle plates 22, 24, and 26, or may extend at an acute angle.

The elastomeric elements 28″ may be less than about the diameter of a traditional non-elastomeric bristle (e.g., nylon), may be about the diameter of a traditional bristle, or may be of a substantially greater diameter, such that they are about the diameter of one or more traditional bristles, or about the diameter of one or more traditional bristle tufts. Multiple elastomeric elements 28″ may be gathered, folded, and stapled in a traditional manner to form an elastomeric tuft of elements (which may also be referred to as an “elastomeric bristle tuft”), or may be intermixed with non-elastomeric bristles to form a “hybrid tuft” (which may also be referred to as a “hybrid bristle tuft”). A single hollow or solid elastomeric element may have its top portion feathered such that multiple smaller elastomeric elements are created at the top portion.

The bristle plates 22, 24, and 26 may also comprise non-elastomeric bristles 30 (shown as a tuft). The elastomeric elements 28′ and 28″ may be less than, the same as, or greater than the height of the non-elastomeric bristles 30. The elastomeric elements 28′ and 28″ may be of a height which is less than some of the non-elastomeric bristles 30 while greater than the height of other non-elastomeric bristles 30. The non-elastomeric bristles 30 and the elastomeric elements 28′ and 28″ may be the about same height. Also, the elastomeric elements 28′ and 28″ may vary in height with each other, such that some are shorter or taller than others. As well, the elastomeric elements 28′ and 28″ may be about the same height.

As shown in FIG. 2, the oscillating bristle plate 22 may comprise one or more elastomeric elements which form one or more prophy cups 28′. The prophy cup 28′ may be various compositions, sizes, shapes, and orientations, as described in U.S. Pat. App. No. 60/439,317, filed Jan. 10, 2003; 60/463,347, filed Apr. 15, 2003; and U.S. Pat. No. 1,255,028, filed Aug. 3, 1917; U.S. Pat. No. 1,268,544, filed Dec. 18, 1916; U.S. Pat. No. 1,588,785, filed Jun. 30, 1924; U.S. Pat. No. 1,720,017, filed Apr. 25, 1928; U.S. Pat. No. 1,907,286, filed Jun. 10, 1931; U.S. Pat. No. 1,918,521, filed Sep. 28, 1932; U.S. Pat. No. 1,935,099, filed Aug. 27, 1932; U.S. Pat. No. 1,992,770, filed May 1, 1931; U.S. Pat. No. 1,993,763, filed Oct. 29, 1934; U.S. Pat. No. 2,093,007, filed Sep. 3, 1935; U.S. Pat. No. 2,189,175, filed May 20, 1938; U.S. Pat. No. 2,202,299, filed Feb. 24, 1936; U.S. Pat. No. 2,789,352, filed Jun. 27, 1955; U.S. Pat. No. 3,195,537, filed Sep. 25, 1962; U.S. Pat. No. 3,452,746, filed Mar. 15, 1967; U.S. Pat. No. 3,727,313, filed Sep. 22, 1971; U.S. Pat. No. 3,939,599, filed, Jul. 12, 1973; U.S. Pat. No. 4,424,036, filed Mar. 18, 1982; U.S. Pat. No. 4,432,729, filed Apr. 23, 1982; U.S. Pat. No. 4,929,180, filed Dec. 7, 1988; U.S. Pat. No. 5,131,846, filed Jan. 16, 1992; U.S. Pat. No. 5,360,339, filed Mar. 1, 1994; U.S. Pat. No. 5,584,690, filed Oct. 12, 1995; U.S. Pat. No. 6,146,140, filed Jul. 7, 1999; and International App. WO 2004/071237, filed Jan. 27, 2004. The prophy cup 28′ may be cylindrical and may be oriented coaxially with an axis of rotation 60 of the oscillating bristle plate 22. A top portion of the prophy 28′ cup may be deeply or slightly concaved. However, the prophy cup 28′ may have a generally flat top portion which may not hold a lot of paste, but may smear the paste against the user's teeth.

The oscillating bristle plate 22 may comprise one or more elastomeric elements which form fingers 28″. The fingers 28″ may be various compositions, sizes, shapes, and orientations, as described in U.S. Pat. No. 6,446,295, filed on Jun. 26, 2000; and U.S. patent application Ser. No. 10/214,687, filed on Aug. 8, 2002; U.S. Ser. No. 10/701,694, filed Nov. 5, 2003; and International Apps. WO 02/11583, filed Aug. 6, 2001; WO 2004/014181, filed Aug. 8, 2003; and WO 2004/014183, filed Aug. 8, 2003. The fingers 28″ may be oriented immediately adjacent to the prophy cup 28′ such that no other bristle or object comes in-between the inner row formed by them.

As shown in FIG. 4, an embodiment may include fingers 28″ oriented in the outer row (also referred to as the “periphery”), as well as the inner row, such that the fingers 28″ in the outer row are taller than the fingers 28″ in the inner row. Alternatively, as shown in FIG. 5, non-elastomeric bristles 30 may be placed between the fingers 28″ in the outer row. From about 2 to about 100, from about 10 to about 80, from about 30 to about 60, from about 40 to about 50, from about 2 to about 8, from about 3 to about 7, from about 4 to about 6, or from about 4 to about 5 elastomeric elements 28′ and 28″ may be placed on a bristle plate, or together in a specific area. The elastomeric elements 28′ and 28″ may be spaced from about 1 to about 10, from about 2 to about 9, from about 3 to about 8, from about 4 to about 7, or from about 5 to about 6 diameters from one another. The elastomeric elements 28′ and 28″ may be arranged such that they do not touch one another, or so that they do touch one another at their lower portion (that is, their attached end portion), but not their top portion (that is, their free end portion), or such that they crowd each other, nearly displacing one another.

The elastomeric elements 28′ and 28″ may be arranged in a line, which is straight or arcuate. The elastomeric elements 28′ and 28″ may be arranged anywhere on a moving bristle plate which is transverse to or in-line with the moving or brushing motion. Additionally, the elastomeric elements 28′ and 28″ may be arranged anywhere on a static bristle plate which is transverse to or in-line with the brushing motion.

The elastomeric elements 28′ and 28″ may be oriented around the circumference of the oscillating bristle plate 22, or along the diameter of the oscillating bristle plate 22. The elastomeric elements 28′ and 28″ may be grouped about the center 40 of the oscillating bristle plate 22, and/or in the middle row area 42 of the oscillating bristle plate 22.

The present invention may additionally include information that will communicate to the consumer, by words and/or by pictures, that use of the invention will provide benefits associated with the elastomeric element(s). This information may include a claim of superiority over other like products. Accordingly, the use of packages in association with information that will communicate to the consumer, by words and or by pictures, that use of the invention will provide the particular and related benefits as previously mentioned above. The information may include, for example, advertising in all of the usual material, as well as statements and icons on the package, or elements of the first package, second package, packaged substance, and/or the package system, to inform the consumer.

All documents cited above are incorporated herein by reference; the citation of any document is not to be construed as an admission that it is prior art with respect to the invention.

While particular embodiments of the invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An electric toothbrush comprising:
a handle having a motor disposed therein;
a head having a longitudinal axis;
a neck disposed between said handle and said head;
a first bristle plate which oscillates or rotates about an axis of rotation; and
a second bristle plate which reciprocates generally transverse to said longitudinal axis of said head, wherein said first bristle plate comprises a plurality of elastomeric elements, including a prophy cup.

2. The electric toothbrush of claim 1, wherein said prophy cup is generally coaxially oriented with said axis of rotation.

3. The, electric toothbrush of claim 2, wherein said plurality of elastomeric elements includes fingers oriented immediately adjacent to said prophy cup.

4. The electric toothbrush of claim 3, wherein said fingers extend at about 90 degrees relative to said first bristle plate.

5. The electric toothbrush of claim 3, wherein said fingers extend at an acute angle relative to said first bristle plate.

6. The electric toothbrush of claim 3, wherein said second bristle plate comprises elastomeric elements.

7. The electric toothbrush of claim 4, wherein a top portion of said prophy cup is slightly concaved.

8. The electric toothbrush of claim 2, wherein said plurality of elastomeric elements includes at least two elastomeric bristle tufts oriented immediately adjacent to said prophy cup.

9. The electric toothbrush of claim 8, wherein said plurality of elastomeric elements includes at least two hybrid bristle tufts oriented immediately adjacent to said prophy cup.

10. The electric toothbrush of claim 3, wherein said first bristle plate comprises a plurality of non-elastomeric bristle tufts, wherein said fingers are shorter than at least one of said plurality of non-elastomeric bristle tufts.

11. The electric toothbrush of claim 10, wherein said plurality of elastomeric elements includes fingers oriented along the periphery of said first bristle plate.

12. An electric toothbrush comprising:
a handle having a motor disposed therein;
a head having a longitudinal axis;
a neck disposed between said handle and said head;
a first bristle plate which oscillates or rotates about an axis of rotation; and
wherein said first bristle plate comprises a prophy cup, wherein said prophy cup is surrounded by a first, second, and third group bristle tufts.

13. The electric toothbrush of claim 12, wherein said prophy cup is surrounded by a plurality of elastomeric fingers.

14. The electric toothbrush of claim 13, wherein said plurality of elastomeric fingers have different diameters.

15. The electric toothbrush of claim 10, wherein said electric toothbrush comprises a second bristle plate which reciprocates generally transverse to said longitudinal axis of said head.

16. The electric toothbrush of claim 12, wherein said first bristle plate comprises angled bristles.

17. The electric toothbrush of claim 16, wherein said first group of bristle tufts is elongated.

18. The electric toothbrush of claim 12, wherein said prophy cup comprises a styrene-ethylene-butylene-styrene block copolymer.

19. An electric toothbrush comprising:
a handle having a motor disposed therein;
a head having a longitudinal axis;
a neck disposed between said handle and said head;
a first bristle plate which oscillates or rotates about an axis of rotation; and
wherein said first bristle plate comprises a prophy cup, wherein said prophy cup is surrounded by a first ring of tufts, wherein said first ring of tufts is surrounded by a second ring of tufts, wherein said first ring of tufts is lower than said second ring of tufts.

20. The electric toothbrush of claim 19, wherein said first ring of tufts comprises a plurality elastomeric fingers.

21. The electric toothbrush of claim 19, wherein said prophy cup comprises a styrene-ethylene-butylene-styrene block copolymer.
